(19) United States
(12) Patent Application Publication
(10) Pub. No.: US 2023/0222260 A1
(43) Pub. Date: Jul. 13, 2023

(54) METHOD FOR CALCULATING BENDING MOMENT RESISTANCE OF INTERNAL UNBONDED POST-TENSIONED COMPOSITE BEAM WITH CORRUGATED STEEL WEBS (CSWS) AND DOUBLE-CONCRETE-FILLED STEEL TUBE (CFST) LOWER FLANGE

(71) Applicants: Guangxi Beitou Highway Construction & Investment Group Co., Ltd., Guangxi (CN); Guangxi University, Guangxi (CN); Guangxi Luchan Construction Investment Co., Ltd., Guangxi (CN); Guangxi Qianglu Engineering Consulting Co., Ltd., Guangxi (CN)

(72) Inventors: Yun ZHANG, Guangxi (CN); Tao YANG, Guangxi (CN); Tingyi LUO, Guangxi (CN); Xiaorong ZHOU, Guangxi (CN); Yuan YE, Guangxi (CN); Ming YANG, Guangxi (CN); Yasen TANG, Guangxi (CN); Xiang LI, Guangxi (CN); Weizhen BAI, Guangxi (CN); Daili WEI, Guangxi (CN); Shijie ZHOU, Guangxi (CN)

(21) Appl. No.: 17/804,033

(22) Filed: May 25, 2022

(30) Foreign Application Priority Data
Jan. 10, 2022 (CN) 202210021983.1

(51) Int. Cl. G06F 30/20; E04C 3/293; E04C 5/08

(52) U.S. Cl. CPC G06F 30/20; E04C 3/293; E04C 5/08; G06F 2111/10

(57) ABSTRACT

A method for calculating a bending moment resistance of an internal unbonded post-tensioned composite beam with corrugated steel webs (CSWs) and a double-concrete-filled steel tube (CFST)lower flange includes: determining a degradation law of sectional flexural rigidity of the internal unbonded post-tensioned composite beam with CSWs and a double-CFST lower flange based on numerical analysis, and establishing a sectional flexural rigidity degradation model of the composite beam. The method can include segmenting a bending moment diagram of the composite beam based on the sectional flexural rigidity degradation model, and establishing a segmented integral equation of IUPS strain increment. The method can include establishing an equilibrium equation of force and a bending moment by considering contributions of concrete, the steel tubes, the upper steel flange, the IUPSs, and reinforcement in the composite beam.

### TECHNICAL FIELD

The present disclosure relates to the technical field of engineering structures, and in particular, relates to a method for calculating a bending moment resistance of an internal unbonded post-tensioned composite beam with corrugated steel webs (CSWs) and a double-concrete-filled steel tube (CFST) lower flange.

### BACKGROUND ART

Bridge engineering has seen the widespread use of post-tensioned composite beams with CSWs, which have the advantages of low deadweight, high prestressing application efficiency, good load-carrying capacity and ductility. Although conventional composite beams with CSWs have superior properties, their lower concrete flanges are still prone to crack in the tension zone under bending moment, thereby affecting adversely the safety and durability of the structure.

In order to solve the above problems, an internal unbonded post-tensioned composite beam with CSWs and a double-CFST lower flange comes into being. The composite beam is composed of an upper concrete flange, the CSWs, a double-CFST lower flange, internal unbonded post-tensioning strands (IUPSs), and sway bracings. Since the CFST lower flange can give full play to the tensile properties of steel, it can effectively avoid the cracking problem of the lower flange and improve the spanning capacity of the composite beam. Arranging the IUPSs in the CFST can avoid the maintenance problem caused by the corrosion of external strands in contact with the outside world, so the economic performance of the composite beam can be improved. Therefore, this composite beam has a broad development prospect. At present, there are still few studies on simplified methods for calculating the bending moment resistance of the internal unbonded post-tensioned composite beam with CSWs and a double-CFST lower flange.

### SUMMARY

An objective of the present disclosure is to provide a method for theoretically calculating a bending moment resistance of an internal unbonded post-tensioned composite beam with CSWs and a double-CFST lower flange through several simple iterative operations, and improve the calculation efficiency and accuracy of the bending moment resistance of the composite beam.

In order to achieve the above objective, the present disclosure provides the following technical solutions:

A method for calculating a bending moment resistance of an internal unbonded post-tensioned composite beam with CSWs and a double-CFST lower flange includes:
determining a degradation law of sectional flexural rigidity of the internal unbonded post-tensioned composite beam with CSWs and a double-CFST lower flange based on numerical analysis, where the composite beam includes an upper concrete flange, the CSWs, a double-CFST lower flange, IUPSs, and sway bracings;
establishing a sectional flexural rigidity degradation model of the composite beam according to the degradation law of the sectional flexural rigidity of the composite beam;
segmenting a bending moment diagram of the composite beam based on the sectional flexural rigidity degradation model, and establishing a segmented integral equation of IUPS strain increment;
establishing an equilibrium equation of force and a bending moment by considering contributions of concrete, the steel tubes, the upper steel flange, the IUPSs, and reinforcement respectively in the composite beam; and
iteratively calculating the bending moment resistance of the composite beam according to the equilibrium equation of the force and the bending moment and the segmented integral equation to obtain a theoretical calculation value of the bending moment resistance of the composite beam.

Optionally, a process of establishing the sectional flexural rigidity degradation model of the composite beam according to the degradation law of the sectional flexural rigidity of the composite beam may specifically include:

establishing the sectional flexural rigidity degradation model

$$\frac{B}{{B}_{0}} = \left\{\begin{matrix}1 0 \leq \frac{M}{{M}_{u}} \leq 0.75 \\ 1.00 - \left(\frac{M}{{M}_{u}} - 0.75\right) 0.75 < \frac{M}{{M}_{u}} \leq 0.85 \\ 0.85 - 4 \left(\frac{M}{{M}_{u}} - 0.85\right) 0.85 < \frac{M}{{M}_{u}} \leq \text{1}\end{matrix}\right)$$

of the composite beam according to the degradation law of the sectional flexural rigidity of the composite beam, where B and B₀ are the sectional secant flexural rigidity and equivalent initial flexural rigidity of the composite beam respectively; and M and Mᵤ are an actual moment at any section and an ultimate bending moment resistance, respectively.

Optionally, a process of segmenting the bending moment diagram of the composite beam based on the sectional flexural rigidity model, and establishing the segmented integral equation of the IUPS strain increment may specifically include:

segmenting the bending moment diagram of the composite beam based on the sectional flexural rigidity degradation model, and establishing the segmented integral equation of the IUPS strain increment

$$\begin{matrix}Δ {ε}_{p} = \frac{{e}_{m}}{{l}_{p}} {\int }_{0}^{{l}_{0}} \frac{M \left(x\right)}{B \left(x\right)} d x \\ = \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x + {\int }_{{l}_{C}}^{{l}_{D}} \frac{M \left(x\right)}{{B}_{4} \left(x\right)} d x +\right) \\ \left({\int }_{{l}_{D}}^{{l}_{0}} \frac{M \left(x\right)}{{B}_{5} \left(x\right)} d x\right] ,\end{matrix}$$

where Δεₚ is the IUPS strain increment at ultimate state; eₘ is an UPS eccentricity relative to the neutral axis of the beam section for the composite beam arranged with straight IUPSs; lₚ is the total IUPS length; l₀ is a clear span of the composite beam; l_{A}, l_{B}, l_{C}, and l_{D} are distances from each segment point to a left end point of the beam after the bending moment diagram of the composite beam is segmented according to the bending moment; M(x) is the sectional bending moment of the composite beam; B(x) is the sectional bending flexural rigidity of the composite beam; and B₁(x), B₂(x), B₃(x), B₄(x), and B₅(x) are the sectional bending flexural rigidity of the composite beam in each segment respectively.

Optionally, a process of establishing the equilibrium equation of the force and the bending moment by considering the contributions of the concrete, the steel tubes, the upper steel flange, the IUPSs, and the reinforcement in the composite beam may specifically include:
establishing the following basic assumptions: (1) The CSWs work in coordination with the upper and lower flanges, and the possible tiny relative slip and shear connection failure at the interface between the CSWs and the flanges are neglected.; (2) the contribution of the CSWs to the bending moment resistance is ignored; (3) the assumption that the plane beam section remains plane after loading is discarded. The normal strain distribution through the depth of the upper and lower flanges remains linear, and the upper concrete flange and the lower concrete-filled steel tube have similar sectional rotation around their own centroid axes.; (4) the tensile strength of concrete is not considered; and (5) shear deformation is not considered when calculating the IUPS strain increment; and
establishing the equilibrium equations of the force and the bending moment
$${σ}_{p} {A}_{p} + {f}_{y} {A}_{t u} = {α}_{1} {f}_{c} b x + {σ}_{f} {A}_{f} + {f}_{r y} {A}_{r} \text{and}$$
$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right)\end{matrix}$$
considering the contributions of the concrete, the steel tubes, the upper steel flange , the IUPSs, and the reinforcement in the composite beam, where Aₚ, Aₜᵤ, A_{f}, and Aᵣ are sectional areas of the IUPSs, the steel tubes, the upper steel flange, and the reinforcement respectively;
σₚ is stress of the IUPS; σ_{f} is stress of the upper steel flange, and since the upper steel flange is very close to the centroid axis of the compression zone, its contribution may be ignored; hₚ, hₜᵤ, h_{f}, and hᵣ are distances from the resultant forces of the IUPSs, the steel tubes, the upper steel flange, and the reinforcement to the top of the upper concrete flange respectively;
f_{y} and f_{ry} are yield strength of the steel tubes and the reinforcement respectively; and
α₁f_{c} and x are the equivalent concrete compressive strength and the depth of the concrete stress block, and b is a width of the upper concrete flange.

A system for calculating a bending moment resistance of an internal unbonded post-tensioned composite beam with CSWs includes:
a sectional flexural rigidity degradation law analysis module, configured to determine a degradation law of sectional flexural rigidity of the internal unbonded post-tensioned composite beam with CSWs and a double-CFST lower flange based on numerical analysis, where the composite beam includes an upper concrete flange, the CSWs, a double-CFST lower flange, IUPSs, and sway bracings;
a sectional flexural rigidity degradation model establishment module, configured to establish a sectional flexural rigidity model of the composite beam according to the degradation law of the sectional flexural rigidity of the composite beam;
a segmented integral equation establishment module, configured to segment a bending moment diagram of the composite beam based on the sectional flexural rigidity model, and establish a segmented integral equation of the IUPS strain increment;
an equilibrium equation establishment module, configured to establish an equilibrium equation of the force and the bending moment by considering the contributions of concrete, the steel tubes, the upper steel flange, IUPSs, and the reinforcement in the composite beam; and
an iterative calculation module for the bending moment resistance, configured to iteratively calculate the bending moment resistance of the composite beam according to the equilibrium equation of the force and the bending moment and the segmented integral equation to obtain a theoretical calculation value of the bending moment resistance of the composite beam.

Optionally, the sectional flexural rigidity degradation model establishment module may specifically include:

a sectional flexural rigidity degradation model establishment unit, configured to establish the sectional flexural rigidity degradation model

$$\frac{B}{{B}_{0}} = \left\{\begin{matrix}1 \text{0} \leq \frac{M}{{M}_{u}} \leq 0.75 \\ 1.00 - \left(\frac{M}{{M}_{u}} - 0.75\right) \text{0} \text{.75<} \frac{M}{{M}_{u}} \leq 0.85 \\ 0.85 - 4 \left(\frac{M}{{M}_{u}} - 0.85\right) \text{0} \text{.85<} \frac{M}{{M}_{u}} \leq 1\end{matrix}\right)$$

of the composite beam according to the degradation law of the sectional flexural rigidity of the composite beam, where B and B₀ are the sectional secant flexural rigidity and equivalent initial flexural rigidity of the composite beam respectively; and M and Mᵤ are an actual moment at any section and an ultimate bending moment resistance, respectively.

Optionally, the segmented integral equation establishment module may specifically include:

a segmented integral equation establishment unit, configured to segment the bending moment diagram of the composite beam based on the sectional flexural rigidity degradation model, and establish the segmented integral equation of the IUPS strain increment

$$\begin{matrix}Δ {ε}_{p} = \frac{{e}_{m}}{{l}_{p}} {\int }_{0}^{{l}_{0}} \frac{M \left(x\right)}{B \left(x\right)} d x \\ = \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x +\right) \\ \left({\int }_{{l}_{C}}^{{l}_{D}} \frac{M \left(x\right)}{{B}_{4} \left(x\right)} d x + {\int }_{{l}_{D}}^{{l}_{0}} \frac{M \left(x\right)}{{B}_{5} \left(x\right)} d x\right] ,\end{matrix}$$

where Δεₚ is the IUPS strain increment at ultimate state; eₘ is an eccentric distance of a centroid of a IUPSs section in any beam section of linear post-tensioned reinforcement relative to a neutral axis of the section; lₚ is the total IUPS length; l₀ is a clear span of the composite beam; l_{A}, l_{B}, l_{C}, and l_{D} are distances from each segment point to a left end point of the beam after the bending moment diagram of the composite beam is segmented according to the bending moment; M(x) is the sectional bending moment of the composite beam; B(x) is the sectional flexural rigidity of the composite beam; and B₁(x), B₂(x), B₃(x), B₄(x), and B₅(x) are the sectional flexural rigidity of the composite beam in each segment respectively.

Optionally, the equilibrium equation establishment module may specifically include:
an equilibrium equation establishment unit, configured to establish the above basic assumptions, and establish the equilibrium equations of the force and the bending moment
$${σ}_{p} {A}_{p} + {f}_{y} {A}_{t u} = {α}_{1} {f}_{c} b x + {σ}_{f} {A}_{f} + {f}_{r y} {A}_{r} \text{and}$$
$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right)\end{matrix}$$
by considering the contributions of the concrete, the steel tubes, the upper steel flange, the IUPSs, and the reinforcement in the composite beam, where Aₚ, Aₜᵤ, A_{f}, and Aᵣ are sectional areas of the IUPSs, the steel tubes, the upper steel flange, and the reinforcement respectively;
σₚ is stress of the IUPSs; σ_{f} is stress of the upper steel flange, and since a distance between the upper steel flange and the compressive force point of concrete is usually small, its contribution may be ignored; hₚ, hₜᵤ, h_{f}, and hᵣ are distances from the resultant forces of the IUPSs, the steel tubes, the upper steel flange, and the reinforcement to the top of an upper concrete flange respectively; f_{y} and f_{ry} are yield strength of the steel tubes and the reinforcement respectively; and α₁f_{c} and x are the equivalent concrete compressive strength and the depth of the concrete stress block respectively, and b is a width of the upper concrete flange.

According to the specific embodiments provided by the present disclosure, the present disclosure discloses the following technical effects:

The present disclosure provides a method and system for calculating a bending moment resistance of an internal unbonded post-tensioned composite beam with CSWs. The method includes: determining a degradation law of sectional flexural rigidity of the internal unbonded post-tensioned composite beam with CSWs and a double-CFST lower flange based on numerical analysis, where the composite beam includes an upper concrete flange, the CSWs, a double-CFST lower flange, IUPSs, and sway bracings; establishing a sectional flexural rigidity degradation model of the composite beam according to the degradation law of the sectional flexural rigidity of the composite beam; segmenting a bending moment diagram of the composite beam based on the sectional flexural rigidity degradation model, and establishing a segmented integral equation of IUPS strain increment; establishing an equilibrium equation of force and a bending moment by considering contributions of concrete, the steel tubes, the upper steel flange, the IUPSs, and reinforcement in the composite beam; and iteratively calculating the bending moment resistance of the composite beam according to the equilibrium equation of the force and the bending moment and the segmented integral equation to obtain a theoretical calculation value of the bending moment resistance of the composite beam. The method provided by the present disclosure can obtain the theoretical calculation value of the bending moment resistance of the internal unbonded post-tensioned composite beam with CSWs and a double-CFST lower flange through several simple iterative operations, thereby improving the calculation efficiency and accuracy of the bending moment resistance of the composite beam.

### BRIEF DESCRIPTION OF THE DRAWINGS

To describe the embodiments of the present disclosure or the technical solutions in the prior art more clearly, the accompanying drawings required in the embodiments are briefly introduced below. Obviously, the accompanying drawings described below are only some embodiments of the present disclosure. Those of ordinary skill in the art may further obtain other accompanying drawings based on these accompanying drawings without creative efforts.

FIG. 1 is a flow chart of a method for calculating a bending moment resistance of an internal unbonded post-tensioned composite beam with CSWs and a double-CFST lower flange provided by the present disclosure;

FIG. 2 is an overall schematic diagram of the internal unbonded post-tensioned composite beam with CSWs and a double-CFST lower flange provided by an embodiment of the present disclosure;

FIG. 3 is a schematic diagram of a sectional flexural rigidity degradation model of the internal unbonded post-tensioned composite beam with CSWs and a double-CFST lower flange provided by the embodiment of the present disclosure;

FIG. 4 is a segmented schematic diagram of a bending moment of a simply supported beam subjected to concentrated load provided by the embodiment of the present disclosure;

FIG. 5 is a schematic diagram of calculation of sectional internal force provided by the embodiment of the present disclosure; and

FIG. 6 is a segmented schematic diagram of a bending moment of the simply supported beam subjected to four-point symmetrical bending provided by the embodiment of the present disclosure.

### DETAILED DESCRIPTION OF THE EMBODIMENTS

The technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a method for calculating a bending moment resistance of an internal unbonded post-tensioned composite beam with CSWs, so as to obtain a theoretical calculation value of the bending moment resistance of the internal unbonded post-tensioned composite beam with CSWs and a double-CFST lower flange through several simple iterative operations, and improve the calculation efficiency and accuracy of the bending moment resistance of the composite beam.

To make the above objective, features, and advantages of the present disclosure clearer and more comprehensible, the present disclosure will be further described in detail below in conjunction with the accompanying drawings and specific implementations.

FIG. 1 is a flow chart of a method for calculating a bending moment resistance of an internal unbonded post-tensioned composite beam with CSWs and a double-CFST lower flange provided by the present disclosure. Referring to FIG. 1, a method for calculating a bending moment resistance of an internal unbonded post-tensioned composite beam with CSWs and a double-CFST lower flange provided by the present disclosure includes the following steps.

Step 101: a degradation law of sectional flexural rigidity of the internal unbonded post-tensioned composite beam with CSWs and a double-CFST lower flange is determined based on numerical analysis.

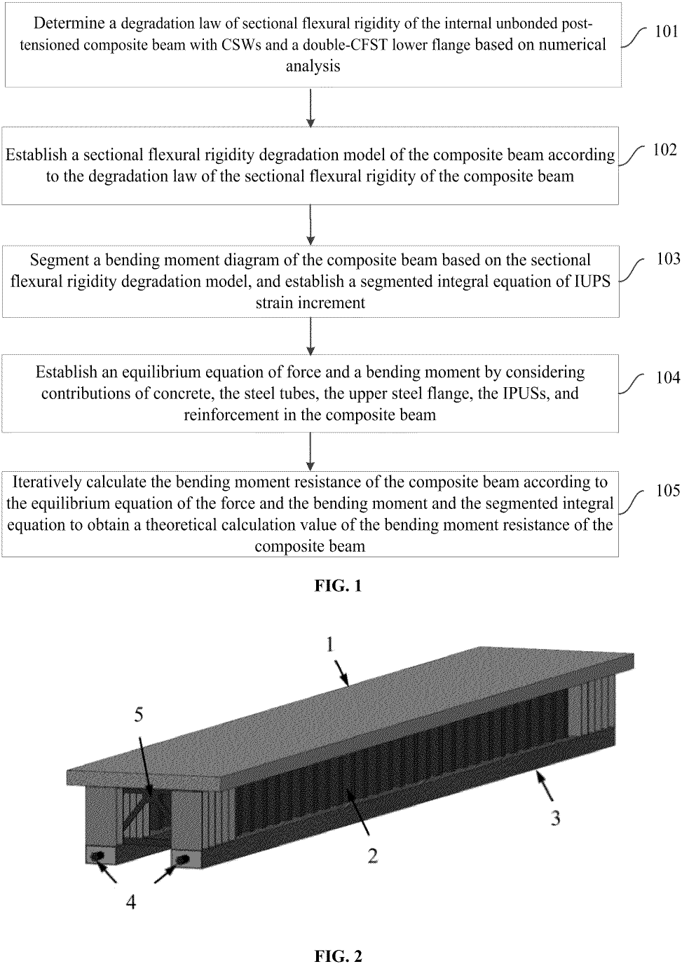

FIG. 2 is an overall schematic diagram of the internal unbonded post-tensioned composite beam with CSWs and a double-CFST lower flange provided by an embodiment of the present disclosure. Referring to FIG. 2, the research object of the method of the present disclosure is the internal unbonded post-tensioned composite beam with CSWs and a double-CFST lower flange. As shown in FIG. 2, the composite beam is composed of an upper concrete flange 1, the CSW 2, a double-CFST lower flange 3, IUPSs 4, and sway bracings 5.

The degradation law of sectional flexural rigidity of the internal unbonded post-tensioned composite beam with CSWs and a double-CFST lower flange can be revealed based on numerical analysis.

Step 102: a sectional flexural rigidity degradation model of the composite beam is established according to the degradation law of the sectional flexural rigidity of the composite beam.

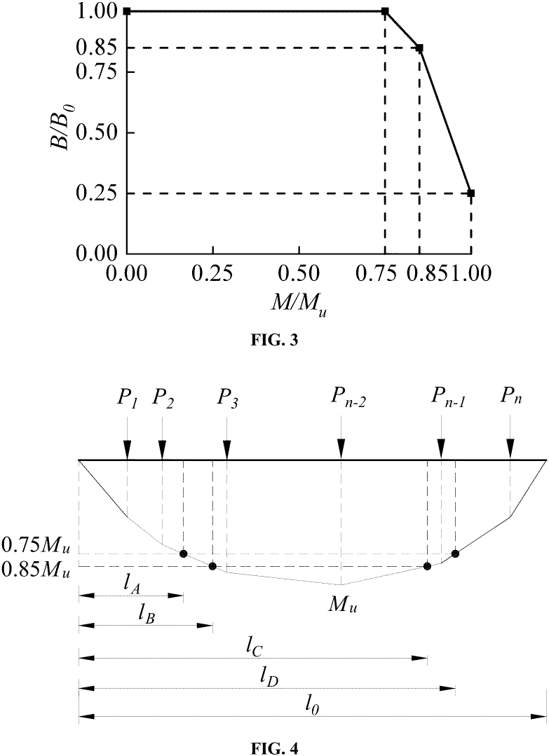

FIG. 3 is a schematic diagram of the sectional flexural rigidity degradation model of the internal unbonded post-tensioned composite beam with CSWs and a double-CFST lower flange provided by the embodiment of the present disclosure. Referring to FIG. 3, according to the present disclosure, the degradation law of the sectional flexural rigidity of the internal unbonded post-tensioned composite beam with CSWs and a double-CFST lower flange is determined based on numerical analysis. Based on this degradation law, the sectional flexural rigidity degradation model (as shown in FIG. 3) and its expression (1) are provided:

$$\frac{B}{{B}_{0}} = \left\{\begin{matrix}1 & 0 \leq \frac{M}{{M}_{u}} \leq 0.75 \\ 1.00 - \left(\frac{M}{{M}_{u}} - 0.75\right) & 0.75 < \frac{M}{{M}_{u}} \leq 0.85 \\ 0.85 - 4 \left(\frac{M}{{M}_{u}} - 0.85\right) & 0.85 < \frac{M}{{M}_{u}} \leq 1\end{matrix}\right)$$

B and B₀ are the sectional secant flexural rigidity and equivalent initial flexural rigidity of the composite beam respectively. M and Mᵤ are a sectional bending moment and the ultimate bending moment resistance of the composite beam respectively.

Therefore, a process of establishing the sectional flexural rigidity degradation model of the composite beam according to the degradation law of the sectional flexural rigidity of the composite beam in step 102 specifically includes the following steps.

The sectional flexural rigidity degradation model

$$\frac{B}{{B}_{0}} = \left\{\begin{matrix}1 \text{0} \leq \frac{M}{{M}_{u}} \leq 0.75 \\ 1.00 - \left(\frac{M}{{M}_{u}} - 0.75\right) \text{0} \text{.75<} \frac{M}{{M}_{u}} \leq \text{0} \text{.85} \\ 0.85 - 4 \left(\frac{M}{{M}_{u}} - 0.85\right) \text{0} \text{.85<} \frac{M}{{M}_{u}} \leq \text{1}\end{matrix}\right)$$

of the composite beam is established according to the degradation law of the sectional flexural rigidity of the composite beam. B and B₀ are the sectional secant flexural rigidity and equivalent initial flexural rigidity of the composite beam respectively. M and Mᵤ are an actual moment at any section and an ultimate bending moment resistance, respectively.

Step 103: a bending moment diagram of the composite beam is segmented based on the sectional flexural rigidity degradation model, and a segmented integral equation of IUPS strain increment is established.

The IUPS strain increment Δεₚ can be calculated as Formula (2):

$$Δ {ε}_{p} = \frac{\text{Δ} {l}_{p}}{{l}_{p}} = \frac{{\int }_{0}^{{l}_{0}} e \left(x\right) {f}^{″} \left(x\right) d x}{{l}_{p}}$$

Δlₚ and lₚ are the elongation and original length of the IUPSs respectively. l₀ is a clear span of the composite beam. e(x) is an eccentric distance of a centroid of a IUPSs section in any beam section relative to a neutral axis of the section, and is a constant eₘ for linear IUPSs. f(x) is a deflection curve of the beam.

According to a curvature expression of a bending member, a relational expression (3) between the sectional curvature ϕ(x) and the sectional bending moment M(x), the sectional flexural rigidity B(x), and the deflection curve of the composite beam f(x) is obtained:

$${f}^{″} \left(x\right) \approx ϕ \left(x\right) = \frac{M \left(x\right)}{B \left(x\right)}$$

The expression (2) of Δεₚ is rewritten by Formula (3) to obtain an approximate calculation formula (4) of Δεₚ:

$$Δ {ε}_{p} \approx \frac{{e}_{m}}{{l}_{p}} {\int }_{0}^{{l}_{0}} \frac{M \left(x\right)}{B \left(x\right)} d x$$

FIG. 4 is a segmented schematic diagram of a bending moment of a simply supported beam subjected to concentrated load provided by the embodiment of the present disclosure. Referring to FIG. 4, the bending moment diagram of the composite beam is drawn according to the load action form actually borne by the composite beam and the boundary conditions, and according to the segment points of the flexural rigidity degradation model (1) of the internal unbonded post-tensioned composite beam with CSWs and a double-CFST lower flange, the bending moment diagram is segmented according to the bending moment.

Specifically, as shown in FIG. 4, the simply supported beam subjected to the concentrated load is taken as an example, and in FIG. 4, Pᵢ(i=1, 2, 3, ···, n) is the concentrated load. The segment points of the sectional flexural rigidity degradation model (1) of the composite beam refer to two points M =0.75 Mᵤ and M =0.85 Mᵤ. Segmenting the bending moment diagram according to the bending moment M means that the bending moment diagram of the composite beam is intercepted by drawing a vertical line to the longitudinal axis of the beam at the segment points M =0.75 Mᵤ and M =0.85 Mᵤ, so as to divide the bending moment diagram into five segments. l_{A}, l_{B}, l_{C}, and l_{D} are distances from each segment point to a left end point of the beam respectively after the bending moment diagram of the composite beam is segmented according to the bending moment. B₁(x), B₂(x), B₃(x), B₄(x), and B₅(x) are the sectional flexural rigidity of the composite beam in each segment respectively.

According to the above segmentation method, segmental integration is performed on Δεₚ to establish the segmented integral equation shown in Formula (5):

$$\begin{matrix}Δ {ε}_{p} = \frac{{e}_{m}}{{l}_{p}} {\int }_{0}^{{l}_{0}} \frac{M \left(x\right)}{B \left(x\right)} d x \\ = \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x +\right) \\ \left({\int }_{{l}_{C}}^{{l}_{D}} \frac{M \left(x\right)}{{B}_{4} \left(x\right)} d x + {\int }_{{l}_{D}}^{{l}_{0}} \frac{M \left(x\right)}{{B}_{5} \left(x\right)} d x\right]\end{matrix}$$

l₀ is the clear span of the beam.

In order to simplify the calculation, the flexural rigidity of each section of the composite beam in each segment can be taken as the average flexural rigidity of the sections of the composite beam in this segment, which is taken according to Formula (6). It should be noted that if there is a pure bending region in the segment, the flexural rigidity of the pure bending region should be taken according to the flexural rigidity degradation model (1).

$$B \left(x\right) = \left\{\begin{matrix}{B}_{0} & 0 \leq M \left(x\right) \leq 0.75 {M}_{u} \\ 0.925 {B}_{0} & 0.75 {M}_{u} < M \left(x\right) \leq 0.85 {M}_{u} \\ 0.55 {B}_{0} & 0.85 {M}_{u} < M \left(x\right) < {M}_{u} \\ 0.25 {B}_{0} & M \left(x\right) = {M}_{u}\end{matrix}\right)$$

Therefore, a process of segmenting the bending moment diagram of the composite beam based on the sectional flexural rigidity degradation model, and establishing the segmented integral equation of IUPS strain increment in step 103 specifically includes the following steps.

The bending moment diagram of the composite beam is segmented based on the sectional flexural rigidity degradation model, and the segmented integral equation of the IUPS strain increment

$$\begin{matrix}Δ {ε}_{p} = \frac{{e}_{m}}{{l}_{p}} {\int }_{0}^{{l}_{0}} \frac{M \left(x\right)}{B \left(x\right)} d x \\ = \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x +\right) \\ \left({\int }_{{l}_{C}}^{{l}_{D}} \frac{M \left(x\right)}{{B}_{4} \left(x\right)} d x + {\int }_{{l}_{D}}^{{l}_{0}} \frac{M \left(x\right)}{{B}_{5} \left(x\right)} d x\right]\end{matrix}$$

is established. Δεₚ is the IUPS strain increment. eₘ is an UPS eccentricity relative to the neutral axis of the beam section for the composite beam arranged with straight IUPSs. lₚ is the total IUPS length. l₀ is a clear span of the composite beam. l_{A}, l_{B}, l_{C}, and l_{D} are distances from each segment point to a left end point of the beam after the bending moment diagram of the composite beam is segmented according to the bending moment. M(x) is the sectional bending moment of the composite beam. B(x) is the sectional flexural rigidity of the composite beam. B₁(x), B₂(x), B₃(x), B₄(x), and B₅(x) are the sectional flexural rigidity of the composite beam in each segment respectively.

Step 104: an equilibrium equation of force and a bending moment is established by considering contributions of concrete, the steel tubes, the upper steel flange, the IUPSs, and reinforcement in the composite beam.

First, the following basic assumptions are established: The CSWs work in coordination with the upper and lower flanges, and the possible tiny relative slip and shear connection failure at the interface between the CSWs and the flanges are neglected.; (2) the contribution of the CSWs to the bending moment resistance is ignored; (3) the assumption that the plane beam section remains plane after loading is discarded. The normal strain distribution through the depth of the upper and lower flanges remains linear, and the upper concrete flange and the lower concrete-filled steel tube have similar sectional rotation around their own centroid axes.; (4) the tensile strength of concrete is not considered; and (5) shear deformation is not considered when calculating the IUPS strain increment.

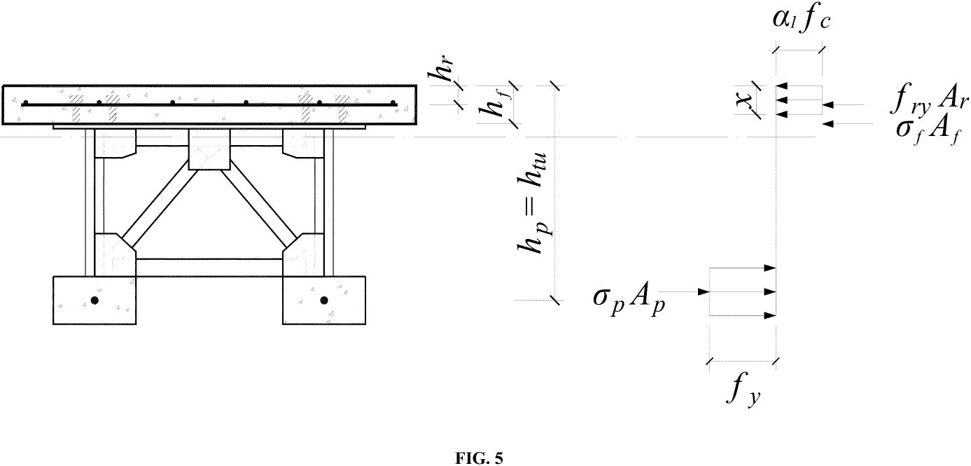

FIG. 5 is a schematic diagram of calculation of sectional internal force provided by the embodiment of the present disclosure. Referring to FIG. 5, considering the contributions of the concrete, the steel tubes, the upper steel flange, the IUPSs, and the reinforcement, a diagram of calculation of sectional internal force during an ultimate state of the bending moment resistance is shown in FIG. 5. The equilibrium equation of the force and the bending moment is shown in Formula (7) and Formula (8).

$${σ}_{p} {A}_{p} + {f}_{y} {A}_{t u} = {α}_{1} {f}_{c} b x + {σ}_{f} {A}_{f} + {f}_{r y} {A}_{r}$$

$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right)\end{matrix}$$

Aₚ, Aₜᵤ, A_{f}, and Aᵣ are sectional areas of the IUPSs, the steel tubes, the upper steel flange, and the reinforcement respectively. σₚ is stress of the IUPSs. σ_{f} is stress of the upper steel flange, and since a distance between the upper steel flange and the compressive force point of concrete is usually small, its contribution may be ignored. hₚ, hₜᵤ, h_{f}, and hᵣ are distances from the resultant forces of the IUPSs, the steel tubes, the upper steel flange, and the reinforcement to the top of an upper concrete flange respectively. f_{y} and f_{ry} are yield strength of the steel tubes and the reinforcement respectively. α₁f_{c} and x are the equivalent concrete compressive strength and the depth of the concrete stress block respectively. ^{b} is a width of the upper concrete flange.

Therefore, a process of establishing the basic assumptions first and then establishing the equilibrium equation of the force and the bending moment by considering the contributions of the concrete, the steel tubes, the upper steel flange, the IUPSs, and the reinforcement in the composite beam in step 104 specifically includes the following steps.

The following basic assumptions are established: (1) the CSWs and the upper and lower flanges work in coordination without relative slip or shear connection failure; (2) the contribution of the CSWs to the bending moment resistance is ignored; (3) the plane section assumption of the entire section is no longer valid, but longitudinal strains of the upper and lower flanges are still linearly distributed within their respective height ranges, and the upper and lower flanges have the same turning angle; (4) the tensile strength of concrete is not considered; and (5) the influence of shear deformation on the elongation of the IUPSs is not considered.

The equilibrium equations of the force and the bending moment

$${σ}_{p} {A}_{p} + {f}_{y} {A}_{t u} = {α}_{1} {f}_{c} b x + {σ}_{f} {A}_{f} + {f}_{r y} {A}_{r} \text{and}$$

$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right) \text{are}\end{matrix}$$

established by considering the contributions of the concrete, the steel tubes, the upper steel flange, the IUPSs, and the reinforcement in the composite beam. Aₚ, Aₜᵤ, A_{f}, and Aᵣ are sectional areas of the IUPSs, the steel tubes, the upper steel flange, and the reinforcement respectively. σₚ is stress of the IUPSs. σ_{f} is stress of the upper steel flange, and since a distance between the upper steel flange and the compressive force point of concrete is usually small, its contribution may be ignored. hₚ, hₜᵤ, h_{f}, and hᵣ are distances from the resultant forces of the IUPSs, the steel tubes, the upper steel flange, and the reinforcement to the top of an upper concrete flange respectively. f_{y} and f_{ry} are yield strength of the steel tubes and the reinforcement respectively. α₁f_{c} and x are the equivalent concrete compressive strength and the depth of the concrete stress block respectively. b is a width of the upper concrete flange.

Step 105: the bending moment resistance of the composite beam is iteratively calculated according to the equilibrium equation of the force and the bending moment and the segmented integral equation to obtain a theoretical calculation value of the bending moment resistance of the composite beam.

A process of iteratively calculating the bending moment resistance of the composite beam according to the equilibrium equations of the force and the bending moment (7) and (8) and the segmented integral equation (5) includes the following specific steps.

Step 5.1: it is assumed that the stress of the IUPSs σₚ is equal to the initial effective prestress σ_{con} corresponding to the initial strain of the IUPSs εₚ₀, and is substituted into the equilibrium equations (7) and (8) for initial iterative calculation to solve the bending moment resistance at the initial stage Mᵤ₀.

Step 5.2: Mᵤ is assigned with Mᵤ₀, and substituted into the equation (6) and the segmented integral equation (5) to calculate the initial strain increment Δεₚ₀.

Step 5.3: during the i-th iterative calculation, the total strain of the IUPSs εₚᵢ = εₚ₍ᵢ₋₁₎ + Δεₚ₍ᵢ₋₁₎ is calculated and the corresponding stress of the IUPSs σₚᵢ is obtained.

Step 5.4: σₚ is assigned with σₚᵢ, and substituted into the equilibrium equations of the force and the bending moment (7) and (8) established in step 104 for the i-th iterative operation to solve the bending moment resistance at the i-th stage Mᵤᵢ.

Step 5.5: Mᵤ is assigned with Mᵤᵢ, and substituted into Formula (6) and the segmented integral equation (5) to calculate the strain increment Δεₚᵢ during the i-th iteration calculation.

Step 5.6: i=i+1 is set, steps 5.3 to 5.5 are repeated until the error of the sectional bending moment obtained in the adjacent iteration steps is less than 5%, and the bending moment resistance calculated in this iteration Mᵤᵢ is used as the theoretical calculation value of the bending moment resistance of the composite beam.

The present disclosure provides a method for calculating a bending moment resistance of an internal unbonded post-tensioned composite beam with CSWs and a double-CFST lower flange. First, the sectional flexural rigidity degradation model of the composite beam is provided. Based on the model, the IUPS strain increment in the beam is calculated by segmental integration. Then, based on the internal force equilibrium equation of the beam section, a simplified method for calculating a bending moment resistance of an internal unbonded post-tensioned composite beam with CSWs and a double-CFST lower flange considering the prestress increment of the IUPSs is provided. Using the simplified calculation method provided by the present disclosure, the theoretical calculation value of the bending moment resistance of the internal unbonded post-tensioned composite beam with CSWs and a double-CFST lower flange can be obtained through several simple iterative operations. Based on the sectional flexural rigidity degradation model of the composite beam, the method of the present disclosure clearly considers the influence of the prestress increment of the internal IUPSs on the bending moment resistance of the composite beam in the whole bending process, which has the characteristics of high efficiency and accuracy.

The implementation process of the method of the present disclosure is further described below through embodiments in combination with the accompanying drawings.

In order to evaluate the accuracy of the method proposed above, numerical analysis is performed by the finite element software ANSYS. 13 internal unbonded post-tensioned composite beams with CSWs and a double-CFST lower flange are designed and subjected to the four-point bending test, and the studied parameters include different cases of the span-to-depth ratio, the concrete compressive strength, the initial effective prestress of IUPSs, the width of the upper concrete flange, and the yield strength of the steel tubes.

The integral expression of the IUPS strain increment in the beam Δεₚ is shown in Formula (4).

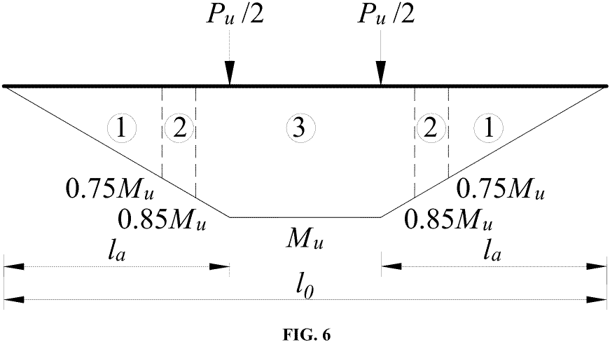

The bending moment diagram of the unbonded post-tensioned composite beam with CSWs and a double-CFST lower flange subjected to four-point symmetrical bending under simply supported conditions is drawn. According to the segment points of the flexural rigidity degradation model provided by the present disclosure, the bending moment diagram is segmented according to the bending moment, as shown in FIG. 6.

Δεₚ is subjected to segmented integration according to Formula (9), the flexural rigidity of the pure bending segment is taken according to the flexural rigidity degradation model (1), the flexural rigidity of the composite beam in other segments is taken as the average flexural rigidity in the section of the composite beam in the segment, and lₐ is the distance from the loading point to the beam end.

$$\begin{matrix}Δ {ε}_{p} = \frac{{e}_{m}}{{l}_{p}} {\int }_{0}^{{l}_{0}} \frac{M \left(x\right)}{B \left(x\right)} d x \\ = \frac{2 {e}_{m}}{{l}_{p}} \left[{\int }_{0}^{0.75 {l}_{a}} \frac{M \left(x\right)}{{B}_{0}} d x + {\int }_{0.75 {l}_{a}}^{0.85 {l}_{a}} \frac{M \left(x\right)}{0.925 {B}_{0}} d x +\right) \\ \left({\int }_{0.85 {l}_{a}}^{{l}_{a}} \frac{M \left(x\right)}{0.55 {B}_{0}} d x + {\int }_{{l}_{a}}^{0.5 {l}_{0}} \frac{M \left(x\right)}{0.25 {B}_{0}} d x\right]\end{matrix}$$

The equilibrium equations of the force and moment of the composite beam section are listed. Since the distance between the centroid of the reinforcement section and the compressive force point of concrete is small, its contribution is ignored. It is assumed that the stress of the IUPSs σₚ is the initial prestress σ_{con} corresponding to the initial strain of the IUPSs εₚ₀, and is substituted into equilibrium equations (7) and (8) for initial iterative calculation to solve the bending moment resistance at the initial stage Mᵤ₀. Mᵤ₀ is substituted into Formula (9) to calculate the initial strain increment Δεₚ₀. The total strain for the first iteration εₚ₁ = εₚ₀ +Δεₚ₀ is calculated and the corresponding stress of the IUPSs σₚ₁ is obtained. The first iterative calculation is performed by substituting σₚ₁ into the equilibrium equation of the force and moment to solve the bending moment resistance at the first stage Mᵤ₁.

The calculation results are shown in Table 1.

TABLE 1

Comparison between theoretical values and the numerical results

| Specimen number | ^{M} _{u0_{[kN·m]}} | ^{M} _{u1_{[kN·m]}} | ^{M} _{e_{[kN·m]}} | Mᵤ₀/Mₑ | Mᵤ₁/Mₑ |
|---|---|---|---|---|---|
| S1 | 759.8 | 802.7 | 869.7 | 87.4% | 92.3% |
| S2 | 614.7 | 649.0 | 705.4 | 87.1% | 92.0% |
| S3 | 905.0 | 956.7 | 1045.4 | 86.6% | 91.5% |
| S4 | 759.8 | 799.7 | 880.3 | 86.3% | 90.8% |
| S5 | 759.8 | 796.0 | 873.5 | 87.0% | 91.1% |
| S6 | 754.5 | 796.9 | 841.2 | 89.7% | 94.7% |
| S7 | 768.8 | 812.7 | 898.2 | 85.6% | 90.5% |
| S8 | 739.3 | 784.6 | 875.0 | 84.5% | 89.7% |
| S9 | 779.6 | 808.5 | 876.6 | 88.9% | 92.2% |
| S10 | 765.5 | 809.3 | 895.6 | 85.5% | 90.4% |
| S11 | 770.1 | 814.7 | 908.4 | 84.8% | 89.7% |
| S12 | 674.6 | 716.2 | 782.3 | 86.2% | 91.5% |
| S13 | 843.4 | 887.0 | 953.7 | 88.4% | 93.0% |

In Table 1, Mₑ is the numerical results of the bending moment resistance of the composite beam. It can be seen from Table 1 that after two iterative calculations are performed according to the simplified calculation method provided by the present disclosure, the obtained theoretical value of the bending moment resistance of the internal unbonded post-tensioned composite beam with CSWs and a double-CFST lower flange has good accuracy, and the maximum error is not more than 10.3% compared with the finite element value.

It can be seen that the method of the present disclosure clearly considers the influence of the prestress increment of the IUPSs on the bending moment resistance of the composite beam in the whole bending process based on the sectional flexural rigidity degradation model of the composite beam, and can obtain the theoretical calculation value of the bending moment resistance of the internal unbonded post-tensioned composite beam with CSWs and a double-CFST lower flange through several simple iterative operations, thereby improving the calculation efficiency and accuracy of the bending moment resistance of the composite beam.

Based on the method for calculating a bending moment resistance of an internal unbonded post-tensioned composite beam with CSWs and a double-CFST lower flange provided by the present disclosure, the present disclosure further provides a system for calculating a bending moment resistance of an internal unbonded post-tensioned composite beam with CSWs and a double-CFST lower flange, including: a sectional flexural rigidity degradation law analysis module, a sectional flexural rigidity degradation model establishment module, a segmented integral equation establishment module, an equilibrium equation establishment module, and an iterative calculation module for the bending moment resistance.

The sectional flexural rigidity degradation law analysis module is configured to determine a degradation law of sectional flexural rigidity of the internal unbonded post-tensioned composite beam with CSWs and a double-CFST lower flange based on numerical analysis. The composite beam includes an upper concrete flange, the CSWs, a double-CFST lower flange, IUPSs, and sway bracings.

The sectional flexural rigidity degradation model establishment module is configured to establish a sectional flexural rigidity degradation model of the composite beam according to the degradation law of the sectional flexural rigidity of the composite beam.

The segmented integral equation establishment module is configured to segment a bending moment diagram of the composite beam based on the sectional flexural rigidity degradation model, and establish a segmented integral equation of IUPS strain increment.

The equilibrium equation establishment module is configured to establish basic assumptions, and establish an equilibrium equation of force and a bending moment by considering contributions of concrete, the steel tubes, the upper steel flange, the IUPSs, and reinforcement in the composite beam.

The iterative calculation module for the bending moment resistance is configured to iteratively calculate the bending moment resistance of the composite beam according to the equilibrium equation of the force and the bending moment and the segmented integral equation to obtain a theoretical calculation value of the bending moment resistance of the composite beam.

The sectional flexural rigidity degradation model establishment module specifically includes: a sectional flexural rigidity degradation model establishment unit.

The sectional flexural rigidity degradation model establishment unit is configured to establish the sectional flexural rigidity degradation model

$$\frac{B}{{B}_{0}} = \left\{\begin{matrix}1 \text{0} \leq \frac{M}{{M}_{u}} \leq 0.75 \\ 1.00 - \left(\frac{M}{{M}_{u}} - 0.75\right) \text{0} \text{.75<} \frac{M}{{M}_{u}} \leq \text{.85} \\ 0.85 - 4 \left(\frac{M}{{M}_{u}} - 0.85\right) \text{0} \text{.85<} \frac{M}{{M}_{u}} \leq 1\end{matrix}\right)$$

of the composite beam according to the degradation law of the sectional flexural rigidity of the composite beam. B and B₀ are the sectional secant flexural rigidity and equivalent initial flexural rigidity of the composite beam respectively. M and Mᵤ are an actual moment at any section and an ultimate bending moment resistance, respectively.

The segmented integral equation establishment module specifically includes: a segmented integral equation establishment unit.

The segmented integral equation establishment unit is configured to segment the bending moment diagram of the composite beam based on the sectional flexural rigidity degradation model, and establish the segmented integral equation of the IUPS strain increment

$$\begin{matrix}Δ {ε}_{p} = \frac{{e}_{m}}{{l}_{p}} {\int }_{0}^{{l}_{0}} \frac{M \left(x\right)}{B \left(x\right)} d x \\ = \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x +\right) \\ \left({\int }_{{l}_{C}}^{{l}_{D}} \frac{M \left(x\right)}{{B}_{4} \left(x\right)} d x + {\int }_{{l}_{D}}^{{l}_{0}} \frac{M \left(x\right)}{{B}_{5} \left(x\right)} d x\right] .\end{matrix}$$

Δεₚ is the IUPS strain increment. eₘ is an UPS eccentricity relative to the neutral axis of the beam section for the composite beam arranged with straight IUPSs. lₚ is the total IUPS length. l₀ is a clear span of the composite beam. l_{A}, l_{B}, l_{C}, and l_{D} are distances from each segment point to a left end point of the beam after the bending moment diagram of the composite beam is segmented according to the bending moment. M(x) is the sectional bending moment of the composite beam. B(x) is the sectional flexural rigidity of the composite beam. B₁(x), B₂(x), B₃(x), B₄(x), and B₅(x) are the sectional flexural rigidity of the composite beam in each segment respectively.

The equilibrium equation establishment module specifically includes: an equilibrium equation establishment unit.

The equilibrium equation establishment unit is configured to establish the basic assumptions, and establish the equilibrium equations of the force and the bending moment

$${σ}_{p} {A}_{p} + {f}_{y} {A}_{t u} = {α}_{1} {f}_{c} b x + {σ}_{f} {A}_{f} + {f}_{r y} {A}_{r} \text{and}$$

$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right) \text{by}\end{matrix}$$

considering the contributions of the concrete, the steel tubes, the upper steel flange, the IUPSs, and the reinforcement in the composite beam. Aₚ, Aₜᵤ, A_{f}, and Aᵣ are sectional areas of the IUPSs, the steel tubes, the upper steel flange, and the reinforcement respectively. σₚ is stress of the IUPSs. σ_{f} is stress of the upper steel flange, and since a distance between the upper steel flange and the compressive force point of concrete is usually small, its contribution may be ignored. hₚ, hₜᵤ, h_{f}, and hᵣ are distances from the resultant forces of the IUPSs, the steel tubes, the upper steel flange, and the reinforcement to the top of an upper concrete flange respectively. f_{y} and f_{ry} are yield strength of the steel tubes and the reinforcement respectively. α₁f_{c} and x are the equivalent concrete compressive strength and the depth of the concrete stress block respectively, and b is a width of the upper concrete flange.

Compared with the prior art, the method and system of the present disclosure has the following outstanding advantages:
(1) The sectional flexural rigidity degradation model of the internal unbonded post-tensioned composite beam with CSWs and a double-CFST lower flange is established based on numerical analysis.
(2) The prestress increment of the IUPSs in the composite beam can be subjected to whole process calculation and evaluation in the bending process.
(3) Through several simple iterative operations, the contribution of the prestress increment of the IUPSs to the bending moment resistance of such composite beam can be considered, which has high calculation efficiency and accurate results.

Each embodiment of the present specification is described in a progressive manner, each embodiment focuses on the difference from other embodiments, and the same and similar parts between the embodiments may refer to each other. Since the system disclosed in the embodiment corresponds to the method disclosed in the embodiment, the description is relatively simple, and reference can be made to the method description.

Specific examples are used herein to explain the principles and implementations of the present disclosure. The foregoing description of the embodiments is merely intended to help understand the method of the present disclosure and its core ideas; besides, various modifications may be made by those of ordinary skill in the art to specific implementations and the scope of application in accordance with the ideas of the present disclosure. In conclusion, the content of the present specification shall not be construed as limitations to the present disclosure.

1. A method for calculating a bending moment resistance of an internal unbonded post-tensioned composite beam with corrugated steel webs (CSWs) and a double-concrete-filled steel tube (CFST) lower flange, comprising:
determining a degradation law of sectional flexural rigidity of the internal unbonded post-tensioned composite beam with CSWs and a double-CFST lower flange based on numerical analysis, wherein the composite beam comprises an upper concrete flange, the CSWs, a double concrete-filled steel tube (CFST) lower flange, internal unbonded post-tensioning strands (IUPSs), and sway bracings;
establishing a sectional flexural rigidity degradation model of the composite beam according to the degradation law of the sectional flexural rigidity of the composite beam;
segmenting a bending moment diagram of the composite beam based on the sectional flexural rigidity degradation model, and establishing a segmented integral equation of IUPS strain increment;
establishing an equilibrium equation of force and a bending moment by considering contributions of concrete, the steel tubes, the upper steel flange, the IUPSs, and reinforcement in the composite beam; and
iteratively calculating the bending moment resistance of the composite beam according to the equilibrium equation of the force and the bending moment and the segmented integral equation to obtain a theoretical calculation value of the bending moment resistance of the composite beam.

2. The method according to claim 1, wherein a process of establishing the sectional flexural rigidity degradation model of the composite beam according to the degradation law of the sectional flexural rigidity of the composite beam comprises:
establishing the sectional flexural rigidity degradation model
$$\frac{B}{{B}_{0}} = \left\{\begin{matrix}1 & 0 \leq \frac{M}{{M}_{u}} \leq 0.75 \\ 1.00 - \left(\frac{M}{{M}_{u}} - 0.75\right) & 0.75 < \frac{M}{{M}_{u}} \leq 0.85 \\ 0.85 - 4 \left(\frac{M}{{M}_{u}} - 0.85\right) & 0.85 < \frac{M}{{M}_{u}} \leq 1\end{matrix}\right)$$
of the composite beam according to the degradation law of the sectional flexural rigidity of the composite beam, wherein B and B₀ are the sectional secant flexural rigidity and equivalent initial flexural rigidity of the composite beam respectively; and M and Mᵤ are an actual moment at any section and an ultimate bending moment resistance, respectively.

3. The method according to claim 2, wherein a process of segmenting the bending moment diagram of the composite beam based on the sectional flexural rigidity degradation model, and establishing the segmented integral equation of the IUPS strain increment comprises:
segmenting the bending moment diagram of the composite beam based on the sectional flexural rigidity degradation model, and establishing the segmented integral equation of the IUPS strain increment
$$\begin{matrix}Δ {ε}_{p} = \frac{{e}_{m}}{{l}_{p}} {\int }_{0}^{{l}_{0}} \frac{M \left(x\right)}{B \left(x\right)} d x = \\ \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x + {\int }_{{l}_{C}}^{{l}_{D}} \frac{M \left(x\right)}{{B}_{4} \left(x\right)} d x + {\int }_{{l}_{D}}^{{l}_{0}} \frac{M \left(x\right)}{{B}_{5} \left(x\right)} d x\right] ,\end{matrix}$$
wherein Δεₚ is the IUPS strain increment at ultimate state; eₘ is an UPS eccentricity relative to the neutral axis of the beam section for the composite beam arranged with straight IUPSs; lₚ is the total IUPS length; l₀ is a clear span of the composite beam; l_{A}, l_{B}, l_{C}, and l_{D} are distances from each segment point to a left end point of the beam after the bending moment diagram of the composite beam is segmented according to the bending moment; M(x) is the sectional bending moment of the composite beam; B(x) is the sectional flexural rigidity of the composite beam; and B₁(x), B₂(x), B₃(x), B₄(x), and B₅(x) are the sectional flexural rigidity of the composite beam in each segment respectively.

4. The method according to claim 3, wherein a process of establishing the equilibrium equation of the force and the bending moment by considering the contributions of the concrete, the steel tubes, the upper steel flange, the IUPSs, and the reinforcement in the composite beam comprises:
establishing the equilibrium equations of the force and the bending moment
$${σ}_{p} {A}_{p} + {f}_{y} {A}_{t u} = {α}_{1} {f}_{c} b x + {σ}_{f} {A}_{f} + {F}_{r y} {A}_{r} \text{and}$$
$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right)\end{matrix}$$
considering the contributions of the concrete, the steel tubes, the upper steel flange, the IUPSs, and the reinforcement in the composite beam, wherein Aₚ, Aₜᵤ, A_{f}, and Aᵣ are sectional areas of the IUPSs, the steel tubes, the upper steel flange, and the reinforcement respectively; (σₚ is stress of the IUPSs; σ_{f} is stress of the upper steel flange; hₚ, hₜᵤ, h_{f}, and hᵣ are distances from the resultant forces of the IUPSs, the steel tubes, the upper steel flange, and the reinforcement to the top of an upper concrete flange respectively; f_{y} and f_{ry} are yield strength of the steel tubes and the reinforcement respectively; and α₁f_{c} and x are the equivalent concrete compressive strength and the depth of the concrete stress block respectively, and b is a width of the upper concrete flange.

5. A system for calculating a bending moment resistance of an internal unbonded post-tensioned composite beam with CSWs and a double-CFST lower flange, comprising:
a sectional flexural rigidity degradation law analysis module, configured to determine a degradation law of sectional flexural rigidity of the internal unbonded post-tensioned composite beam with CSWs and a double-CFST lower flange based on numerical analysis, wherein the composite beam comprises an upper concrete flange, the CSWs, a double-CFST lower flange, IUPSs, and sway bracings;
a sectional flexural rigidity degradation model establishment module, configured to establish a sectional flexural rigidity degradation model of the composite beam according to the degradation law of the sectional flexural rigidity of the composite beam;
a segmented integral equation establishment module, configured to segment a bending moment diagram of the composite beam based on the sectional flexural rigidity degradation model, and establish a segmented integral equation of IUPS strain increment;
an equilibrium equation establishment module, configured to establish an equilibrium equation of force and a bending moment by considering contributions of concrete, the steel tubes, the upper steel flange, the IUPSs, and reinforcement in the composite beam; and
an iterative calculation module for the bending moment resistance, configured to iteratively calculate the bending moment resistance of the composite beam according to the equilibrium equation of the force and the bending moment and the segmented integral equation to obtain a theoretical calculation value of the bending moment resistance of the composite beam.

6. The system according to claim 5, wherein the sectional flexural rigidity degradation model establishment module comprises:
a sectional flexural rigidity degradation model establishment unit, configured to establish the sectional flexural rigidity degradation model
$$\frac{B}{{B}_{0}} = \left\{\begin{matrix}1 & 0 \leq \frac{M}{{M}_{u}} \leq 0.75 \\ 1.00 - \left(\frac{M}{{M}_{u}} - 0.75\right) & 0.75 < \frac{M}{{M}_{u}} \leq 0.85 \\ 0.85 - 4 \left(\frac{M}{{M}_{u}} - 0.85\right) & 0.85 < \frac{M}{{M}_{u}} \leq 1\end{matrix}\right)$$
of the composite beam according to the degradation law of the sectional flexural rigidity of the composite beam, wherein B and B₀ are the sectional secant flexural rigidity and equivalent initial flexural rigidity of the composite beam respectively; and M and Mᵤ are an actual moment at any section and an ultimate bending moment resistance, respectively.

7. The system according to claim 6, wherein the segmented integral equation establishment module comprises:
a segmented integral equation establishment unit, configured to segment the bending moment diagram of the composite beam based on the sectional flexural rigidity degradation model, and establish the segmented integral equation of the IUPS strain increment
$$\begin{matrix}Δ {ε}_{p} = \frac{{e}_{m}}{{l}_{p}} {\int }_{0}^{{l}_{0}} \frac{M \left(x\right)}{B \left(x\right)} d x = \\ \frac{{e}_{m}}{{l}_{p}} \left[{\int }_{0}^{{l}_{A}} \frac{M \left(x\right)}{{B}_{1} \left(x\right)} d x + {\int }_{{l}_{A}}^{{l}_{B}} \frac{M \left(x\right)}{{B}_{2} \left(x\right)} d x + {\int }_{{l}_{B}}^{{l}_{C}} \frac{M \left(x\right)}{{B}_{3} \left(x\right)} d x + {\int }_{{l}_{C}}^{{l}_{D}} \frac{M \left(x\right)}{{B}_{4} \left(x\right)} d x + {\int }_{{l}_{D}}^{{l}_{0}} \frac{M \left(x\right)}{{B}_{5} \left(x\right)} d x\right] ,\end{matrix}$$
wherein Δεₚ is the IUPS strain increment at ultimate state; eₘ is an UPS eccentricity relative to the neutral axis of the beam section for the composite beam arranged with straight IUPSs; lₚ is the total IUPS length; l₀ is a clear span of the composite beam; l_{A}, l_{B}, l_{C}, and l_{D} are distances from each segment point to a left end point of the beam after the bending moment diagram of the composite beam is segmented according to the bending moment; M(x) is the sectional bending moment of the composite beam; B(x) is the sectional flexural rigidity of the composite beam; and B₁(x), B₂(x), B₃(x), B₄(x), and B₅(x) are the sectional flexural rigidity of the composite beam in each segment respectively.

8. The system according to claim 7, wherein the equilibrium equation establishment module comprises:
an equilibrium equation establishment unit, configured to establish the equilibrium equations of the force and the bending moment
$${σ}_{p} {A}_{p} + {f}_{y} {A}_{t u} = {α}_{1} {f}_{c} b x + {σ}_{f} {A}_{f} + {f}_{r y} {A}_{r \text{and}}$$
$$\begin{matrix}{M}_{u} = {σ}_{p} {A}_{p} \left({h}_{p} - \frac{x}{2}\right) + {f}_{y} {A}_{t u} \left({h}_{t u} - \frac{x}{2}\right) - {σ}_{f} {A}_{f} \left({h}_{f} - \frac{x}{2}\right) - \\ {f}_{r y} {A}_{r} \left({h}_{r} - \frac{x}{2}\right)\end{matrix}$$
by considering the contributions of the concrete, the steel tubes, the upper steel flange, the IUPSs, and the reinforcement in the composite beam, wherein Aₚ, Aₜᵤ, A_{f}, and Aᵣ are sectional areas of the IUPSs, the steel tubes, the upper steel flange, and the reinforcement respectively; σₚ is stress of the IUPSs; σ_{f} is stress of the upper steel flange; hₚ, hₜᵤ, h_{f}, and hᵣ are distances from the resultant forces of the IUPSs, the steel tubes, the upper steel flange, and the reinforcement to the top of an upper concrete flange respectively; f_{y} and f_{ry} are yield strength of the steel tubes and the reinforcement respectively; and α₁f_{c} and x are the equivalent concrete compressive strength and the depth of the concrete stress block respectively, and b is a width of the upper concrete flange.
